(19) United States
(12) Patent Application Publication
(10) Pub. No.: US 2019/0236698 A1
(43) Pub. Date: Aug. 1, 2019

(54) METHOD AND SYSTEM FOR RECONCILING THE EXCHANGE OF CRYPTOCURRENCIES UTILIZING BLOCKCHAIN

(71) Applicant: Richard Postrel, Miami Beach, FL (US)

(72) Inventor: Richard Postrel, Miami Beach, FL (US)

(21) Appl. No.: 16/256,554

(22) Filed: Jan. 24, 2019

Related U.S. Application Data
(60) Provisional application No. 62/622,568, filed on Jan. 26, 2018.

(51) Int. Cl. G06Q 40/04; G06Q 20/40; H04L 9/06

(52) U.S. Cl. CPC G06Q 40/04; H04L 2209/38; H04L 9/0643; G06Q 20/4016

(57) ABSTRACT

A computer-based process for reconciling the exchange of cryptocurrencies comprising a user initiating a transaction in a marketplace using a cryptocurrency; inputting a plurality of risk factors; assessing a level of risk as a function of the risk factors; recording the assessed risk level in a blockchain ledger; obtaining a security interest in the transaction blockchain as a function of the assessed risk level; assessing a transaction fee based on the assessed risk and/or security interest; recording the transaction fee in the blockchain ledger; and closing out the blockchain transaction.

### BACKGROUND

Cryptocurrencies that are built on blockchain technologies, such as Bitcoin, are becoming more and more prevalent. One major attraction of the cryptocurrencies of today are that they provide for anonymity for the parties using the cryptocurrency as a means of payment or exchange. Although this has led to the popular belief that cryptocurrencies are used for nefarious purposes, the use of cryptocurrency for standard business transactions is beginning to emerge.

The greatest impediments to cryptocurrencies becoming part of a standard business practice and achieving large globalized scalability is its lack of transparency and governance, which leads to the large swings in value, extended transaction times, extreme volatility, huge spreads, and significant fees. People who require anonymity are willing to suffer these negative aspects of cryptocurrencies as they currently exist. These issues as well as a lack of an established infrastructure for management and oversight of cryptocurrencies has led to speculative interests entering from all aspects of the marketplace, including a number of well-established firms. However, in each of these cases, the focus is on selling the asset without the ability to hedge, short or securitize. In order to resolve these issues, a certain degree of transparency and oversight is required, which necessitates reconciliation between two opposing needs—the need for anonymity and the need for transparency.

This invention addresses the layer of infrastructure that is presently lacking to create a bifurcated marketplace which allows for both the existing infrastructure necessitating anonymity to collaborate and coexist with an infrastructure requiring transparency and securitization that can be applied as a series of layers that can collaborate from one to the other.

### SUMMARY

Provided is a computer-based process for reconciling the exchange of cryptocurrencies comprising a user initiating a transaction in a marketplace using a cryptocurrency; inputting a plurality of risk factors; assessing a level of risk as a function of the risk factors; recording the assessed risk level in a blockchain ledger; obtaining a security interest in the transaction blockchain as a function of the assessed risk level; assessing a transaction fee based on the assessed risk and/or security interest; recording the transaction fee in the blockchain ledger; and closing out the blockchain transaction.

### DESCRIPTION OF THE DRAWING

FIG. 1 is a block diagram of the cryptocurrency exchange system of the preferred embodiment.

FIG. 2 is a flowchart of one aspect of the operation of the cryptocurrency exchange system of the preferred embodiment.

FIG. 3 is a flowchart of another aspect of the operation of the cryptocurrency exchange system of the preferred embodiment.

FIG. 4 is a pictorial of a sliding scale between anonymity and transparency.

### DETAILED DESCRIPTION OF THE PREFERRED EMBODIMENTS

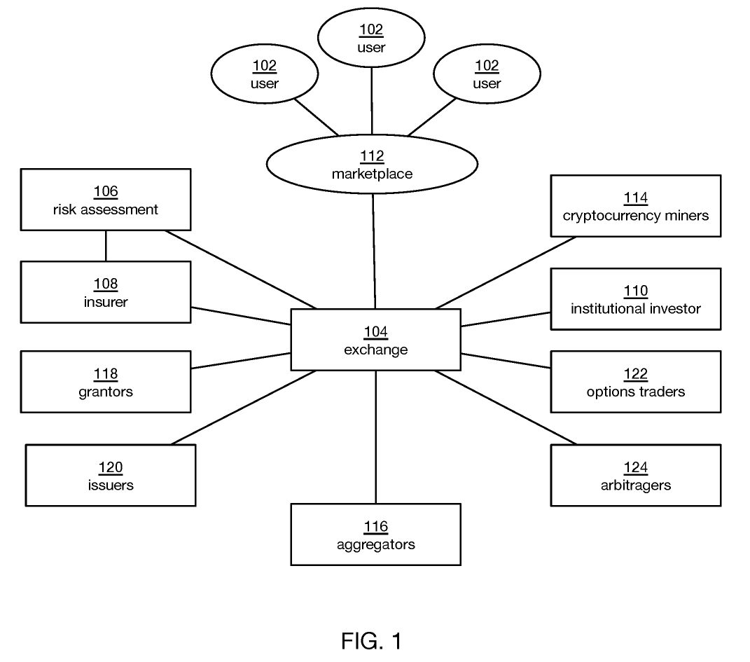

With reference to FIG. 1, the following definitions are provided, which are explained in further detail in the remaining description.

102—user—any type of cryptocurrency investor, or an entity that uses a cryptocurrency as a medium of exchange or purchase, such as with a merchant, for example an individual or closely-held entity. User may fall into a certain tier, based on the value being exchanged, as explained further herein.

104—cryptocurrency exchange—trading and exchange platform of the preferred embodiment through which all parties interoperate. The exchange, which is comprised of one or more server computers interoperating in the cloud, provides the means by which users may sell cryptocurrencies, exchange cryptocurrencies, and/or invest other funds into cryptocurrencies, which are aggregated by the exchange to make such investment.

106—risk assessment—a computing platform that assigns a risk factor(s) to a cryptocurrency or other blockchain ledger as a function of various factors as described herein.

108—insurer—an entity that underwrites a cryptocurrency/blockchain ledger, as a function of the risk assessment.

110—institutional investor—an entity that aggregates individual investments made by the users.

112—marketplace—represents the transaction infrastructure; i.e. merchants, financial institutions, and the like, that interoperate with the exchange 104 as explained herein.

114—cryptocurrency miners—as well known in the art, mining is the process by which transactions are verified and added to the public ledger, known as the block chain, and also the means through which new cryptocurrency are released.

116—aggregators—entities that aggregate individual cryptocurrency transactions into laerger transactions

118—grantors—entities that own cryptocurrencies and are willing to cover trades by others, i.e. will lend a cryptocurrency to another while a mining process is undertaken.

120—issuers—entities that grant options based on what the grantors make available

122—options traders—entities that work with institutional investors

In the embodiment described, provided is a cryptocurrency infrastructure solution, exchange and securitization system and methodology that addresses the aforementioned problems of the existing marketplace. In one aspect, the cryptocurrency is an insurable interest. A risk factor may be assigned to the cryptocurrency, and optionally may be included in the underlying blockchain ledger. This risk factor is based on various criteria, including the underlying platform, number of transactions undertaken by the blockchain, the average value of the cryptocurrency, the total volume, various price points, and the depository of the ledger.

A higher risk factor, indicative of more volatility of the cryptocurrency, creates a higher cost to secure the cryptocurrency, which in turn creates a higher transaction cost. The securitization (i.e. insurance) could be accessed in the event of various predefined criteria occurring as explained herein. The cost of the securitization for the cryptocurrency is part of the transaction fee(s) that are assessed in a given cryptocurrency transaction. As the reliability of the cryptocurrency increases, the risk factor decreases, and as a result the securitization cost decreases.

The cryptocurrency exchange functions as a clearinghouse, in that it manages a transaction utilizing the cryptocurrency. A fee is charged by the clearinghouse, which is related to the risk factor described above. That is, a cryptocurrency carrying a higher risk factor in its blockchain ledger will cause a higher transaction fee to be charged by the exchange. This transaction fee is imposed as a function of the time to finalize the cryptocurrency transaction,

The risk factors of a blockchain generated as per above may be securitized so as to enable spreading the risk amongst entities that wish to participate in the securitization. Variables that are considered when securitizing the blockchain/risk include but are not limited to:
Number of transactions undertaken by the blockchain
Average value (in the case of a cryptocurrency)
Total volume
Price points
Depository of the ledger

By securitizing the blockchain, multiple blockchains may be pooled or aggregated together to form an investment pool, which may in turn be invested in by multiple investors, thus spreading the risk as a function of the number of blockchains in the pool as well as the number of investors in the pool.

Transactions using a cryptocurrency as a means of payment are advantageous in that they can leverage, under this embodiment of the invention, many parameters that vary based on the particulars of the transaction. These parameters become part of the blockchain ledger that underlies the cryptocurrency used in the transaction, and/or the blockchain ledger that may attach to or be associated with the item being conveyed in the transaction. Some of the parameters that are used in this embodiment include, but are not limited to, the following transaction risk factors:
Category—the product type that used the classify or categorize the product, which may be as granular as desired. For example, a used may be purchasing a certain television, in which case, the category may be electronics, home entertainment, TV, etc.
Geography/location—the location or region where the transaction is occurring is specified, which also may be as granular as desired (such as United States, New York, Albany, etc.).
Value—the value of the transaction, which is typically the purchase price, but which may be related to some other valuation of the transaction (e.g. the value of a TV being purchased is $600, but the actual cost of the TV is $500 since it is on sale.
Merchant—this identifies the merchant that is selling the item in the transaction.
Time/date stamp—this is a recording of the actual time and date that the transaction has been initiated and/or completed.
Uniqueness—this parameter will indicate if a transaction is a one-off transaction on that is being repeated at a relatively high frequency, which may be indicative if a fraudulent attempt. For example, a request to purchase plumbing services in a remote town in Russia, for the same price and from the same merchant, which occurs at a high frequency in a short amount of time, is indicative of an attempt to perpetuate a fraudulent transaction.

Users may be classified in this embodiment into different tiers, as follows.
Tier 1—a tier 1 user implements an everyday spend, which is classified as being under a certain amount, such as $500. Typically, this would be a consumer making a typical purchase as defined by the transaction criteria above.
Tier 2—a tier 2 user executes higher value transactions that are in excess of the tier 1 user, e.g. financial transactions, money transfer transactions, and the like.

Using the information described above, an analysis is made by risk assessment block 106 to ascertain a level of risk that the proposed transaction will endure. An algorithm may be employed that operates on the transaction risk factors to provide a risk factor for that proposed transaction. The calculated risk factor may be used to filter out and decline certain transactions deemed too risky, i.e. assumed to be fraudulent. The risk factor may also be used on a sliding scale to assign a transaction fee as a function of the risk, and/or to implement a settlement delay time to ensure the validity of the transaction prior to settlement.

Exchange 104 represents one or more server computers that interoperate in the cloud to provide the mechanism for executing the transaction using cryptocurrency as a means for payment as described herein. Although FIG. 1 illustrates a single exchange 104, in fact many smaller exchanges 104 may be used in isolation or in association with each other to perform the desired functions in a distributed but centralized manner.

The marketplace 112 represents the existing transaction infrastructure; i.e. merchants, financial institutions, and the like, that interoperate with the exchange 104 as explained herein. For example, a proposed cryptocurrency transaction will be routed to the exchange 104 in order to provide risk assessment and securitization in a manner previously unavailable.

Risk assessment block 106 is a server computer or group of computers that manage the transaction risk factors explained above, perform an algorithmic assessment of the risk, and then determines the fee structure for a proposed transaction based on that calculated risk. In addition, a requested transaction may be denied in its entirety if the calculated risk becomes too high. Assuming the transaction may however go forward, the calculated risk that is determined by the risk assessment function 106 is provided to the insurer 108, which functions to securitize the risk in accordance with the risk factor it is provided.

Cryptocurrency miners 114 represent the services and computers that mine cryptocurrency as known in the art. Essentially, these miners 114 operate on transactions and the blockchain ledger to verify a given cryptocurrency transaction and ensure that the ledger is accurate and up-to-date. The insurer 108 will insure the transactions, as a function of the risk assessment 106, until the cryptocurrency miners have competed those tasks.

The aggregators 116 may be used to aggregate a multiplicity of cryptocurrency transactions from one or more merchants, serving as a clearinghouse as well (the exchange 104 may if desired execute the functions of the aggregators 116). That is, the aggregators will pool or aggregate various cryptocurrencies together and seek a purchaser so the merchants can monetize their transactions, hedged by the risk assessment 106.

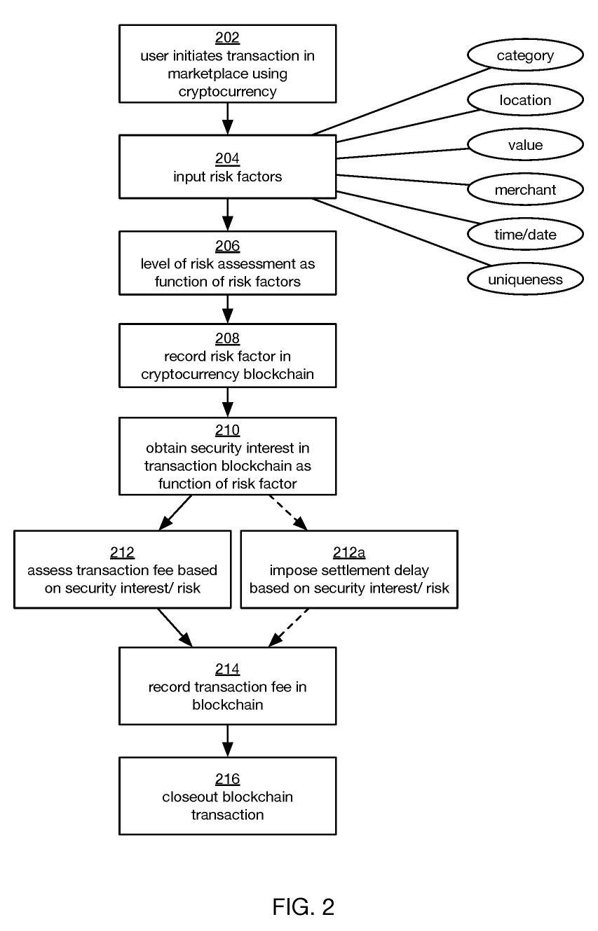

FIG. 2 illustrates a flowchart of a typical transaction in accordance with this embodiment. At step 202, a tier 1 user 102 (e.g. typical consumer) initiates a transaction with a merchant in the marketplace 112. The user 102 tenders payment for the transaction using a cryptocurrency such as Bitcoin. The merchant will then interact with the exchange 104 in order to execute the cryptocurrency transaction, using an associated blockchain ledger, as follows. At step 204, various risk factors are input into the risk assessment module 106. These factors include the category of the transaction being requested, the location of the merchant and/or user in the transaction, the value of the transaction (e.g. purchase price), the identity of the merchant, the time and date of the transaction, and a uniqueness factor as explained above. These risk factors may be obtained from the blockchain ledger that is part of the transaction request, or they may be obtained from external sources. At step 206, the risk assessment module utilizes the risk factors that have been gathered and performs an algorithmic analysis to generate a risk factor for the requested cryptocurrency transaction. At step 208, the risk factor is recorded in the cryptocurrency blockchain ledger and becomes a permanent part of the cryptocurrency.

At step 210, a security interest is created in the transaction blockchain as a function of the security risk factor, and at step 212 a transaction fee is assessed that is based on the security interest (risk) in the transaction. That is, the higher the risk factor, the more expensive the security interest is for that blockchain ledger. Optionally, at step 212a, a settlement delay may also be imposed based on the risk. In this manner, a transaction that is deemed high risk may be delayed until payment has been secured in order to flush out any fraudulent transaction attempts.

At step 214, the transaction fee is recorded in the blockchain ledger, and the transaction is closed out at step 216.

Thus, the exchange enables competing risk pools to purchase blocks of blockchain liability, which can have either a fixed or variable value and time with a premium or contango associated. The resulting differentials will lead to a trading or arbitrage opportunity that the major “market makers” will be able to trade off of.

In one embodiment, a consumer purchases an item from a merchant for a certain amount of cryptocurrency. That merchant will then seek to sell the cryptocurrency in order to monetize that cryptocurrency. The merchant can interoperate with an aggregator intermediary, which functions to aggregate cryptocurrency transaction from multiple merchants, and seek the best return in terms of standard currency (e.g. US dollars). There is a certain amount of delay time associated with this aggregation and monetization transaction, which is a risk undertaken by the merchant and/or aggregator. At this point, the securitization methodology described herein will take place, so that the aggregator becomes the guarantor.

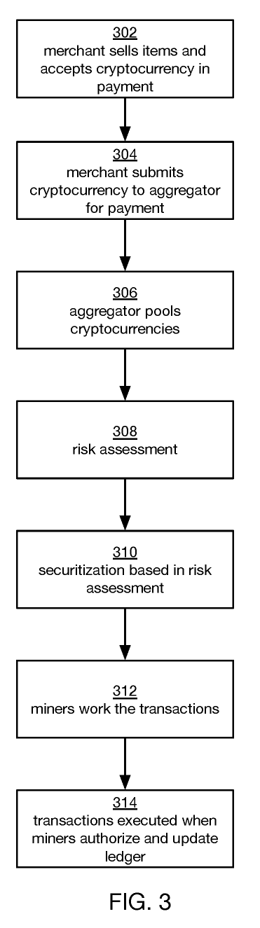

This is shown in FIG. 3. At step 302 the merchant sells an item(s) to a consumer/user, and accepts cryptocurrency in payment. At step 304 the merchant submits the cryptocurrency to an aggregator, who at step 306 may pool other cryptocurrencies together for payment in the open market. The risk assessment is undertaken at step 308, and at step 310 the securitization takes place based on the risk assessment as described above. The miners work the transactions at step 312, and at step 314, the transaction are executed when the miners authorize and update the blockchain ledger.

In some embodiments, different groups of users will undertake risk factors, and as a result will have differing levels of risk. Accordingly, different levels of users will also have different levels of transparency through the cryptocurrency transactions. Each level of users may be interdependent on each other. One helpful analogy is to consider a group of cylinders that interoperate in the manner of tumblers in a lock. That is, each cylinder must align with its adjacent cylinder in order for the entirety to successfully continue. For example, a first cylinder may execute a cryptocurrency ecosystem as it exists in the prior art. A second cylinder, adjacent to the first cylinder, would add another layer of operability, obtaining certain data from the first cylinder in order to proceed. A third cylinder, adjacent to the second cylinder, would add yet another layer of operability, also obtaining certain data from the second cylinder in order to proceed. This may go on as desired. As a result, the last cylinder can only operate alongside each of the preceding cylinders, since each is dependent on the previous cylinder. This is a similar paradigm to the blockchain ledger, in which records in the blockchain include keys from previous record as its hash function.

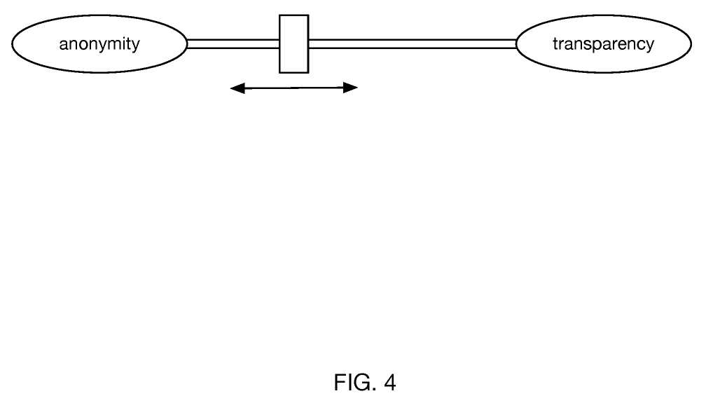

In another aspect of the invention, the system may be looked at as a series of layers in a securitized wafer, each one interconnecting with the other in a continuing series paradigm, transferring information/data to the next as may be needed based on the parameters of the transaction sought to be accomplished. This recognizes the dichotomy between two groups of users; on one end are those requiring anonymity, and on the other end those requiring transparency. In between these two distinct groups of users are those with requirements for both anonymity and transparency in differing amounts, thus equating to a sliding scale between both extremes. Historically, the users that require anonymity have been those utilizing the blockchain-cryptocurrency paradigm, but it is only recently that groups of users have emerged that are willing to forego some anonymity in exchange for transparency, and thus a greater trust in the cryptocurrency exchange/transaction methodology. FIG. 4 illustrates this paradigm.

This sliding scale is realized via the blockchain. A sequential grouping of records is used to transfer data, as needed, from one record to the next. Since the blockchain is secure, there is no danger that records will be deleted or edited; each record depends on the data in the previous record as known in the art. However, in this embodiment, only certain data is transferred to the next record, and new data may be added as needed. For example, starting at the point of anonymity, only certain data is contained within the blockchain. Users requiring anonymity would interact with the blockchain at this point. As users interact, more data may be added to the records in sequence, thus adding transparency a little bit at a time. As more transparency is added to sequential records (via the addition of data), trust in the transaction strings is increased, and users that require less anonymity and more transparency may then interact with the blockchain. More and more trusted data is added to each record as the slider traverses towards the transparency bubble in FIG. 4, until the transactions feature virtually no anonymity and all transparency. Other users may interact with the blockchain at any point in the sliding scale of FIG. 4 as may be desired.

What is claimed is:

1. A computer-based process for reconciling the exchange of cryptocurrencies comprising:
a. a user initiating a transaction in a marketplace using a cryptocurrency;
b. inputting a plurality of risk factors;
c. assessing a level of risk as a function of the risk factors;
d. recording the assessed risk level in a blockchain ledger;
e. obtaining a security interest in the transaction blockchain as a function of the assessed risk level;
f. assessing a transaction fee based on the assessed risk and/or security interest;
g. recording the transaction fee in the blockchain ledger; and
h. closing out the blockchain transaction.

2. The process of claim 1 further comprising imposing a settlement delay based on the assessed risk and/or security interest.

3. The process of claim 1 wherein the risk factors comprise at least one of category, location, vale, merchant, time and/or date, and uniqueness.
